(19) United States
(12) Patent Application Publication
(10) Pub. No.: US 2007/0290405 A1
(43) Pub. Date: Dec. 20, 2007

(54) Polyphosphate glasses as a plasticizer for nylon

(76) Inventors: Joshua Otaigbe, Hattiesburg, MS (US); Kevin Urman, Lugoff, SC (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/717,934

(22) Filed: Mar. 14, 2007

Related U.S. Application Data
(60) Provisional application No. 60/782,105, filed on Mar. 14, 2006.

(51) Int. Cl. C08K 9/00; B32B 7/00

(52) U.S. Cl. 264/328.1; 523/205; 524/612

(57) ABSTRACT

The present invention discloses the miscibility of inorganic phosphate glass and organic polymer prepared by blending both components in the liquid phase using conventional polymer processing methods. By utilizing low Tg phosphate glasses to plasticize nylon, e.g. polyamide 6, a new class of plasticizer is introduced that allows for the creation of unique nylon polymer composites. These materials display tunable morphologies, interesting properties, and significant reduction in flammability, while easing the processing of nylon through a substantial reduction of viscosity. The addition of a low Tg phosphate glass in small amounts (less than 10% by volume) to a nylon matrix results in a drastic reduction in viscosity and a decrease in the nylon glass transition temperature and flammability, with the capability of adding a low Tg phosphate glass up to 60% by volume. The observed mechanical properties of the nylon/phosphate glass hybrid are consistent with that of plasticized polymers.

This application claims the benefit of provisional application Ser. No. 60/782,105 filed Mar. 14, 2006.

The United States government may own rights in the present invention pursuant to grant numbers DMR 9733350 and DMR 0309115 from the National Science Foundation.

### BACKGROUND OF THE INVENTION

Inorganic glass fillers are common reinforcements used in polymer composites to achieve enhanced mechanical properties at a low cost. However, it is only possible to add a small amount of glass (approximately 30% by weight) to a polymer system before the resultant intractable viscosity makes it impossible to process via extrusion and injection molding. A new class of inorganic glass fillers is emerging that eliminates the viscosity limitation just mentioned. Low glass transition temperature (Tg) phosphate glasses (Pglass) that are both water-resistant and chemically durable are now available (1, 2). J. U. Otaigbe and G. H. Beall, Trends in Polymer Science, 5, 369-379 (1997) reviews inorganic phosphate glasses as polymers and is herein incorporated by reference in its entirety. These glasses have found applications in the biomedical, laser, and optical fields. Due to their inherently low Tg (e.g., 120° C.), these Pglasses can be melt processed with many different polymers utilizing conventional processing methods such as extrusion and injection molding. Previous work reported in the literature has shown that the addition of Pglass fillers to polymer matrices results in a material that is stiff, strong, creep-resistant, and dimensionally stable at high temperatures (3-7). The special morphologies and properties displayed by this class of inorganic-organic hybrids, stems from the fact that both hybrid components are fluid during processing, allowing for molecular level (i.e. single phase) mixing of the components. The miscibility or immiscibility of the two components, as well as the crystalline properties of the polymer matrix, will greatly affect the final properties and morphology of the material. The crystalline characteristics of a classical polymer blend are often greatly affected by the addition of a different, amorphous polymer. These crystallization effects can be observed by monitoring the growth rate and shape of the crystals that are formed (9). While the effect of interactions and miscibility on morphology has been studied for many different polymer blends (10-12), there are relatively few investigations on the miscibility of polyamides with other polymers (13, 14). Miscibility is often enhanced in blend or hybrid systems where there is a large potential for interactions between the components, which can eliminate the intractable viscosity problem inherent to conventional polymer composites at high solid filler compositions.

It has been reported that certain Pglass compositions will bind amine groups to the glass surface (15). This classical interaction is expected to facilitate a high degree of interaction between nylon, e.g. polyamide 6 or polyamide 12, and Pglass phases, thereby encouraging both miscibility in the melt and polymer/glass adhesion in the solid state. Good polymer/glass adhesion is often achieved in conventional glass-filled polymer composites through coupling agents that promote interaction between the glass filler and polymer matrix (16). Although there is currently no theoretical model to predict the final morphology of a blend or hybrid, it is generally accepted that the interactions between the phases in a blend or hybrid play a large role in determining the final morphology. Because the morphology and crystalline properties strongly influence the final material properties, a good, basic understanding of these characteristics will provide better insight into the behavior of these relatively new hybrid materials. Because both the organic polymer and Pglass components pf the present invention are fluid during processing, it is possible to obtain a variety of morphologies and significant improvements in properties that are impossible to achieve from classical polymer blends and composites.

### SUMMARY OF THE INVENTION

The present invention provides a nylon polymer composite comprising a low glass transition temperature phosphate glass and a nylon polymer. In a preferred embodiment, the phosphate glass is a tin fluorophosphate glass. The nylon polymer is, for example, polyamide 6 or polyamide 12. The present invention is also directed to a method of making a nylon composite comprising melt mixing a low transition temperature phosphate glass and a nylon polymer. By blending Pglasses with organic polymers, a relatively new class of inorganic-organic hybrid materials was developed that can contain more than 90% by weight (60% by volume) of the glass phase. These hybrid materials have a unique combination of material properties unavailable from either conventional polymer blends or composites. In addition to unique properties, these materials display interesting morphologies that can be tuned during processing. These materials show promise to fulfill the ever increasing need for a wide range of new materials and applications from already existing materials. Previously, it has been unknown how the two components of these hybrid systems interact. The miscibility and the chi interaction parameter (χ) for a nylon, e.g. polyamide 6 or polyamide 12, and Pglass hybrid using melting point depression techniques are disclosed herein. The crystallization behavior and its effect on the mechanical properties of this new and exciting Pglass/polymer hybrid material is also disclosed. The overall morphology of each hybrid is relatively similar. Each hybrid displays Pglass droplets that range in size, with the smallest observed particle being 0.33 μm. This range is due to droplet coalescence which can also be observed in the SEM micrographs. The glass droplets also appear to be completely encased by the nylon, which indicates good interaction between the phases.

The present invention is the first reported evidence of miscibility between the Pglass and nylon, e.g. polyamide 6, polyamide 12, components. By blending these Pglasses with organic polymers, we developed a relatively new class of inorganic-organic hybrid materials that contains more than 90% by weight (60% by volume) of the glass phase. The phosphate glass component of the present invention is any suitable phosphate glass, for example, tin fluorophosphate glass. The most important property of the phosphate glass is their low glass transition temperature. With such a low Tg, it is possible to blend these Pglasses with organic polymeric materials using conventional processing methodologies to yield hybrid materials containing Pglass loadings of 60% by volume or 90% by weight, thereby eliminating the intractable viscosity problem inherent to conventional polymer composites at high solid filler compositions. Because both the organic polymer and Pglass components are fluid during processing, it is possible to obtain a variety of morphologies and significant improvements in properties that are impossible to achieve from classical polymer blends and composites. The polymer component of the present invention is any suitable polyamide or nylon polymer, for example, polyamide 6, nylon 6,6 or nylon 12. The special morphologies and properties displayed by this class of inorganic-organic hybrids, stems from the fact that both hybrid components are fluid during processing, allowing for molecular level (i.e. single phase) mixing of the components.

In addition to providing a new class of miscible material systems, this invention will have an impact on products made from nylon, e.g. polyamide 6. By utilizing low Tg phosphate glasses to plasticize nylon 6, we are able to introduce a new class of plasticizer that allows for the creation of unique nylon 6 composites. These materials display tunable morphologies, interesting properties, and significant reduction in flammability, while easing the processing of nylon 6 through a substantial reduction of viscosity. The present invention eliminates the difficulty of the prior art where addition of inorganic fillers such as calcium carbonate and silicate glasses as cost extenders and property modifiers of plastics often increased the viscosity of the plastic especially at high filler concentrations, making the filled plastic difficult to melt process using extrusion or injection molding, with the present invention having the added benefit of imparting flame resistance and gas/liquid barrier resistance to the phosphate glass/nylon 6 hybrid or composite. The composite or hybrid derived from this invention has the advantages of conventional plastic composites but without their disadvantages. The special morphologies and properties displayed by this class of inorganic-organic hybrids, stems from the fact that both hybrid components are fluid during processing, allowing for molecular level (i.e. single phase) mixing of the components. Melting point depression is a very good indication of miscibility between two polymers. The drop in melting point is attributed to thermodynamically favorable interactions between the polymers. The miscibility and the chi interaction parameter (χ) for a nylon, e.g. polyamide 6, and Pglass hybrid using melting point depression techniques to show the miscibility of the components in the hybrid material, or nylon polymer composite, is disclosed.

Although the complex interplay between the processing conditions, material parameters, and droplet breakup and coalescence is not fully understood, by systematically varying the blend concentration and processing conditions such as melt-mixing speed (or shear rate) one can begin to elucidate the complex processing/structure/property relationships within a blend. This methodology is applied herein to the Pglass/polymer hybrids, providing the knowledge needed to tailor the hybrid morphology and properties in unprecedented ways through carefully controlled processing and, in turn, provide a basis for further theory development and a better understanding of the behavior of these materials. Pglass/polyamide 12 hybrids are used herein to explore the processing/structure/property relationships where the physical and chemical interactions between —OH (from Pglass) and the —NH₂ (from polyamide 12) chemical functional groups of the hybrid components are significantly increased. Here, the dependence of the rheological, crystalline, and tensile properties on processing history and the resultant morphology over a wide range of compositions is emphasized.

### BRIEF DESCRIPTION OF DRAWINGS

FIG. 1. Hoffman-Weeks plots for the Pglass/polyamide 6 hybrid materials with the Pglass volume percent indicated.

FIG. 2. Melting point depression of the Pglass/polyamide 6 hybrid as a function of composition.

FIG. 3. Scanning electron micrographs of Pglass/polyamide 6 with (a) 2% Pglass, (b) 5% Pglass, and (c) 10% Pglass.

FIG. 4. Temperature dependence of storage modulus data for the Pglass/polyamide 6 hybrids with the Pglass volume percent indicated.

FIG. 5. Typical stress/strain curves for the hybrid materials with the Pglass volume percent indicated for polyamide 6.

FIG. 6. Typical stress/strain curves for the hybrid materials with the Pglass volume percent indicated for polyamide 12 10% Pglass.

FIG. 7. Typical stress/strain curves for the hybrid materials with the Pglass volume percent indicated for polyamide 12 20-50% P glass.

### DETAILED DESCRIPTION OF THE INVENTION

The present invention is the first reported evidence of miscibility between phosphate glass (Pglass) and nylon, e.g. polyamide 6, components. The phosphate glass component of the present invention is any suitable phosphate glass, for example, tin fluorophosphate glass. The hybrids can contain from about 1% to about 60% by volume of Pglass. The most important property of the phosphate glass is their low glass transition temperature. The polymer component of the present invention is any suitable polyamide or nylon polymer, for example, polyamide 6 or polyamide 12.

By blending these Pglasses with organic polymers, we developed a relatively new class of inorganic-organic hybrid materials that contains more than 90% by weight (60% by volume) of the glass phase. These hybrid materials, or nylon polymer composites, have a unique combination of material properties unavailable from either conventional polymer blends or composites. In addition to unique properties, these materials display interesting morphologies that can be tuned during processing. These materials show promise to fulfill the ever increasing need for a wide range of new materials and applications from already existing materials. Possible applications for these hybrid materials include load bearing composites, porous films and tubes, flame retardants, biomaterials, laser fusion systems and fluorescent phosphorescent devices.

The special morphologies and properties displayed by this class of inorganic-organic hybrids, stems from the fact that both hybrid components are fluid during processing, allowing for molecular level (i.e. single phase) mixing of the components. The miscibility or immiscibility of the two components, as well as the crystalline properties of the polymer matrix, will greatly affect the final properties and morphology of the material. The crystalline characteristics of a classical polymer blend are often greatly affected by the addition of a different, amorphous polymer. These crystallization effects can be observed by monitoring the growth rate and shape of the crystals that are formed (9). While the effect of interactions and miscibility on morphology has been studied for many different polymer blends (10-12), there are relatively few investigations on the miscibility of polyamides with other polymers (13, 14). Miscibility is often enhanced in blend or hybrid systems where there is a large potential for interactions between the components.

It has been reported that certain Pglass compositions will bind amine groups to the glass surface (15). This classical interaction is expected to facilitate a high degree of interaction between nylons, such as nylon 6, 6,6 and 12, and Pglass phases, thereby encouraging both miscibility in the melt and polymer/glass adhesion in the solid state. Good polymer/glass adhesion is often achieved in conventional glass-filled polymer composites through coupling agents that promote interaction between the glass filler and polymer matrix (16). Although there is currently no theoretical model to predict the final morphology of a blend or hybrid, it is generally accepted that the interactions between the phases in a blend or hybrid play a large role in determining the final morphology. Because the morphology and crystalline properties strongly influence the final material properties, a good, basic understanding of these characteristics will provide better insight into the behavior of these relatively new hybrid materials. Previously, it has been unknown how the two components of these hybrid systems interact. The miscibility and the chi interaction parameter (χ) for a nylon, e.g. polyamide 6, and Pglass hybrid using melting point depression techniques as well as the crystallization behavior and its effect on the mechanical properties of this new and exciting Pglass/polymer hybrid material, or nylon polymer composite, are disclosed herein. Pglass/polyamide 12 hybrids are used herein to explore the processing/structure/property relationships where the physical and chemical interactions between —OH (from Pglass) and the —NH₂ (from polyamide 12) chemical functional groups of the hybrid components are significantly increased. Here, the dependence of the rheological, crystalline, and tensile properties on processing history and the resultant morphology over a wide range of compositions is emphasized.

Using melting point depression measurements, we obtained a small, negative χ of −0.067. The Pglass was also found to greatly affect the crystalline properties of the crystallizable component of the hybrid. The addition of a small amount of Pglass causes a decrease in the percent crystallinity. The growth rates and shape factors of the crystals, extracted from the Avrami equation, appear to be compositionally dependent. The glass transition data as well as the mechanical properties indicate a plasticizing effect of the Pglass on the nylon, e.g. polyamide 6. A 10-degree drop in the glass transition temperature was observed.

### EXAMPLES

### Example 1

### Phosphate Glass/Polyamide 6 Hybrid Materials

Tin Fluorophosphate glass displays good water resistance and chemical durability, is non-toxic and results from a simple synthesis. The low Tg Pglass used in this example has a molar composition of 50% SnF₂₊₂₀% SnO+30% P₂O₅. This results in a glass with a density of 3.75 g/cc and a Tg of 125.7° C. The glass was synthesized in our laboratory using procedures reported by B. S. Adalja, J. U. Otaigbe and J. Thalacker, Polymer Engineering and Science, 41, 1055-1067 (2001), herein incorporated by reference in its entirety (7). The tin fluoride and tin oxide were supplied by Cerac Inc. and the ammonium phosphate was supplied by Sigma-Aldrich. The polyamide 6 used was Capron 8270 HS supplied by Allied Signal.

The hybrids were prepared using a Thermo-Haake Polydrive® Melt Mixer equipped with roller rotors. Nylon polymer composites containing 1%, 2%, 5%, and 10% Pglass by volume were made for testing. Preparation of the hybrid involves placing the polyamide in the mixer applying heat and a shear rate. Once a homogenous melt is achieved, the Pglass is added and the mixture melt-mixed until homogenized completely. The materials were collected in “chunks” from the Polydrive®. Small pieces of these chunks were microtomed and mounted on an aluminum post using superglue for scanning electron microscopy (SEM). A FEI Quanta® 200 SEM was used to take the micrographs. A portion of the material was compression molded into thin films at 250° C. for DSC studies. Another portion of the material was ground into fine particles using an IKA® A11 basic laboratory mill for injection molding. The fine particles were molded into either dogbone shapes or into small rectangular bars using a DACA Microinjector® equipped with the appropriate mold. A residence time of 10 seconds, a barrel temperature of 250° C., and a mold temperature of 40° C. were used to obtain good samples with reproducible properties. All the DSC and DMA samples were dried in a vacuum oven at 65° C. for several days or until a constant weight was achieved prior to testing.

A Perkin-Elmer Pyris Diamond® DSC was used in the melting point and crystallization experiments. For the dynamic mechanical analysis studies, an ARES® rheometer in torsion mode was utilized. The ARES® instrument was equipped with the solid torsion bar tools and the test was conducted at a rate of 1 Hz under 1% strain. A temperature ramp of 5° C./min was used and a temperature range of −5° C. to 130° C. was examined. The DMA samples used for these tests were 1 mm thick and 5 mm wide. The glass transition temperature for these materials was taken as the maximum in the loss modulus versus temperature data. The dogbone samples were conditioned in ambient conditions for 1 week prior to testing.

The dogbone samples used in the tensile mechanical property testing were 4.32 mm wide, 1.55 mm thick, and the gauge length was 28.70 mm. The samples were deformed at a rate of 5.08 mm/min. in an Alliance RT/10® Material Testing System. Five samples were tested at each composition and the values were averaged to obtain the final results reported in this article.

Melting Point Depression and Miscibility

Melting point depression is a very good indication of miscibility between two polymers. The drop in melting point is attributed to thermodynamically favorable interactions between the polymers. The melting point depression has been used to successfully calculate χ between two components of a blend in many different systems (14, 17-19). One such treatment of melting point depression was reported by Nishi and Wang (20). Nishi and Wang based their work on that previously reported by Flory and Huggins, who described the interaction between polymers under thermodynamic equilibrium, as shown in eq. (1) (21).

$$\frac{1}{{T}_{mb}^{o}} - \frac{1}{{T}_{m}^{o}} = - \frac{{RV}_{c}}{Δ {H}_{f}^{o} {V}_{a}} ⌊ \begin{matrix}\frac{ln {φ}_{c}}{{x}_{c}} + ( \frac{1}{{x}_{c}} - \frac{1}{{x}_{a}} ) ( 1 - {φ}_{c} ) + \\ {χ ( 1 - {φ}_{c} )}^{2}\end{matrix} ⌋ \qquad ( 1 )$$

In this equation, T^{o}ₘ and T^{o}_{mb} are the equilibrium melting points of the crystalline polymer and the blend or hybrid, respectively. The subscripts a and c refer to the amorphous and crystalline components of the hybrid, V is the molar volume of the repeat unit of the polymer, φ is the volume fraction of the specified component, and R is the universal gas constant. ΔH^{o}_{f} is the heat of fusion of the crystalline component, x is the degree of polymerization and χ is the Flory-Huggins chi interaction parameter. For a large degree of polymerization that is typical of polymers, and neglecting the entropic contributions, Nishi and Wang showed that eq. (1) reduces to eq. (2). It should be noted, that eq. (2) suggests that melting point depression must be due to some level of miscibility between the components of the material system.

$$\frac{1}{{T}_{mb}^{0}} - \frac{1}{{T}_{m}^{0}} = \frac{- {RV}_{c}}{Δ {H}_{f}^{o} {V}_{a}} χ {φ}_{a}^{2} \qquad ( 2 )$$

Plotting the left hand side of eq. (2) versus the volume fraction of the amorphous component squared, should result in a straight line that passes through the origin. From the slope of this line, Nishi and Wang were able to calculate χ for a polymer blend of an amorphous and a semi-crystalline polymers.

In the case of the Pglass/polyamide 6 hybrids of the present study, the Pglass was taken as the amorphous polymer. Pglasses are known to be completely amorphous and have distributions of chain lengths and are considered to be inorganic polymers (22-25). The repeat unit of the Pglass must be known in order to calculate the molar volume (Vₐ) of the repeat unit of the Pglass. The repeat unit (shown below) of the Pglass used here was first proposed by Tick and was further supported by Day and coworkers (22-24).

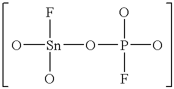

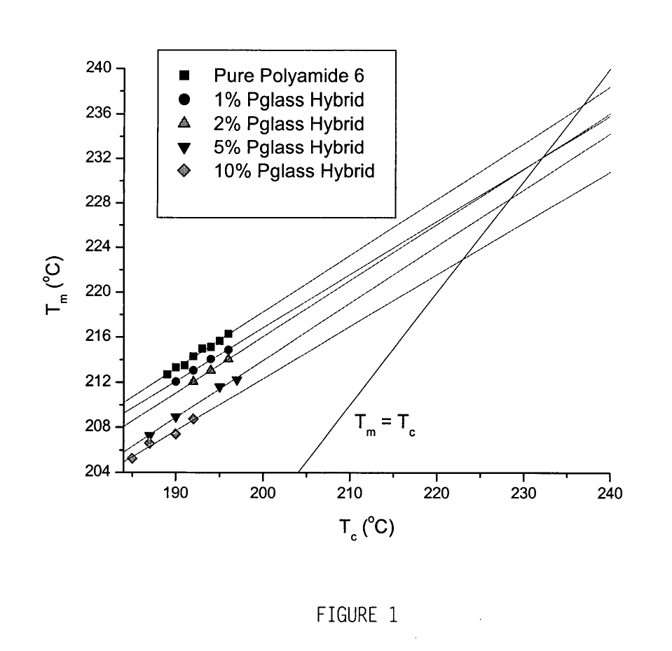

The heat of fusion value of the polyamide 6 used in the present calculations was 190 kJ/kg (26). It is also necessary to determine the equilibrium melting points of the pure polyamide 6 and the hybrids. The equilibrium melting points were determined using the Hoffman-Weeks approach (27). In this method, the equilibrium melting point is derived by plotting the observed melting point (Tₘ) versus the crystallization temperature (T_{c}). This should result in a linear plot (27). The intersection of this plot with the line T_{c}=Tₘ is taken to be the equilibrium melting point of the material. Although the Hoffman-Weeks approach does not account for lamellar thickening, it is widely used to determine the equilibrium melting temperatures for many polymer systems (9). FIG. 1 illustrates typical Hoffman-Weeks plots that were obtained for the hybrid materials. For the purpose of clarity, the observed equilibrium melting points for the Pglass/polyamide 6 hybrids are reported in Table 1.

TABLE 1
Equilibrium Melting Points (T°ₘ) Determined from DSC measurements.

| Vol. % | Vol. % | |
|---|---|---|
| Polyamide 6 | Pglass | T°ₘ (C.) |
| 100 | 0 | 236 ± 1.44 |
| 99 | 1 | 232 ± 3.57 |
| 98 | 2 | 232 ± 0.32 |
| 95 | 5 | 228 ± 0.57 |
| 90 | 10 | 222 ± 0.96 |

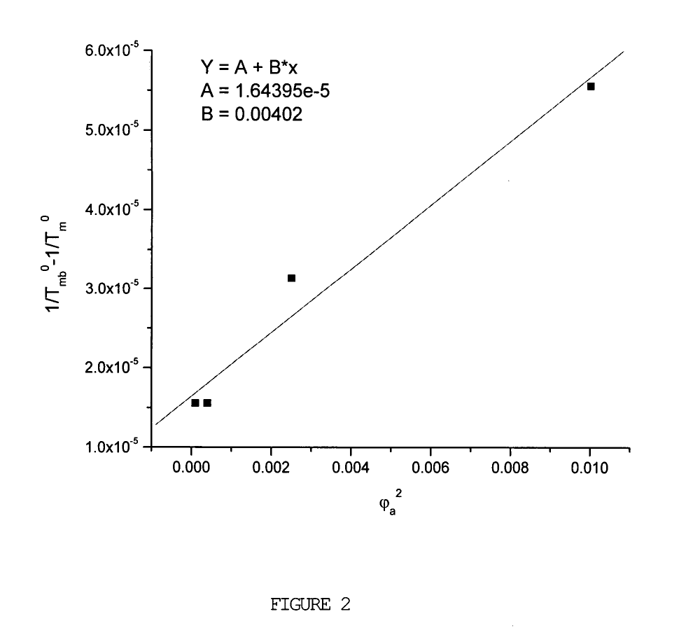

The equilibrium melting point value for the pure polyamide 6 agrees with values reported in the literature (28). By plotting the melting point depression as a function of the volume fraction of Pglass, a straight line with an intercept close to zero is obtained (FIG. 2). The fit of the linear line gives an R² value greater than 0.98. Using the slope of the line from FIG. 2, and Equation 2, χ was calculated to be −0.067. This value satisfies the condition for polymer miscibility and indicates that the Pglass and the polyamide 6 are indeed miscible in the melt. To our knowledge, this is the first reported evidence of miscibility of inorganic glass and organic polymer that may provide a new entry into their basic polymer science studies, as well as, a versatile route to other new materials, which, we hope will lead to new applications for existing materials.
Crystallization Kinetics

The crystalline properties and crystallization kinetics of the hybrid materials were studied using the Avrami equation. The two parameter Avrami equation was used to describe the crystallization kinetics of these systems because it has been used successfully by a number of researchers on many different systems (29, 30). The Avrami equation, eq. (3), describes the percent crystallinity of a system as a function of time, t, and temperature, T.
X_{c}(t,T)=1−exp[−(kt)ⁿ] (3)
X_{c} is the degree of crystallinity and k and n are constants. The constant k is the propagation rate constant of the crystal and it has units of reciprocal time, while n is a dimensionless number that depends on the nucleation, geometry, and control of the growth process of the crystal. The crystallization temperature used was 190° C. Other temperatures (not shown) were evaluated, but the isotherm observed at these temperatures for the higher Pglass contents was extremely poor. The percent crystallinity of the materials was estimated using a slightly modified eq. (4).

$${X}_{c} = \frac{( ω ⋆ Δ {H}_{obs} )}{Δ {H}_{f}^{o}} \qquad ( 4 )$$

In eq. (4), ΔH_{obs} is the heat of fusion observed in the DSC experiment, ΔH^{o}_{f} is the standard heat of fusion of a 100% crystalline polyamide 6, and ω is the weight percent of Polyamide 6 that is in the hybrid. The ω term of this equation was added to account for the fact that polyamide 6 is the only crystallizable component of the hybrid. The Avrami parameters and the percent crystallinity that were determined from the DSC experiments are summarized in Table 2.

TABLE 2
Avrami Parameters for the hybrids determined at 190° C.

| Vol. % | | | Percent |
|---|---|---|---|
| Polyamide 6 | Growth Rate | Shape | Crystallinity |
| in Hybrid | (min⁻¹) | Factor | (%) |
| 100 | 0.189 | 2.7 | 22 ± 0.92 |
| 99 | 0.243 | 3.0 | 22 ± 0.45 |
| 98 | 0.384 | 2.7 | 20 ± 1.14 |
| 95 | 0.070 | 2.4 | 17 ± 0.17 |
| 90 | 0.033 | 2.3 | 12 ± 0.09 |

From this table, it is apparent that small amounts of Pglass have little effect on the geometry of the crystals. The shape actor obtained in the present study for the pure polyamide 6 is consistent with that previously reported in the literature (28). A shape factor of 3 indicates heterogeneous, three dimensional spherical growth. However, the addition of small amounts of Pglass was found to dramatically affect the growth rate of the crystals, indicating that the Pglass is acting as a nucleating agent for the crystals. This observed trend changes as 5% by volume of the Pglass is added to the system. The 5% and 10% Pglass/polyamide 6 hybrids show a decrease in both the growth rate of the crystals and the shape factor. The change in crystalline behavior is also noted in the lower shape factor that indicates heterogeneous, two dimensional, circular growth. The Pglass also affects the overall percent crystallinity of the hybrid material. The addition of >2% Pglass causes a decrease in the calculated percent crystallinity. Clearly, this experimental fact will have a large impact on the mechanical properties of the hybrid. The Pglass does not act like a typical nucleating agent in that while it increases the polyamide 6 crystal growth rates at certain Pglass concentrations, it can cause a decrease in the percent crystallinity. This is most likely due to the fact that the Pglass in the hybrid is fluid at temperatures greater than 125° C.
Mechanical Properties and Hybrid Morphology

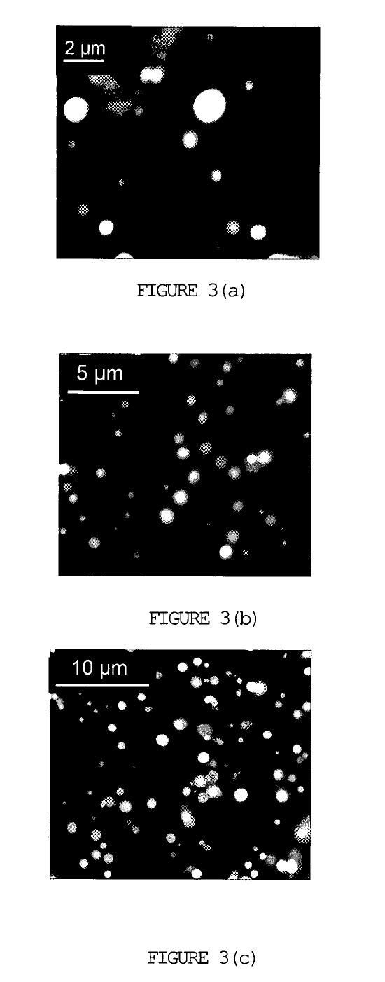

Because this is the first reported case of miscibility between the organic and inorganic phases of a Pglass/polymer hybrid, the mechanical properties and overall morphology resulting from such a material are of great interest. SEM was used to obtain the micrographs shown in FIG. 3. The overall morphology of each hybrid is relatively similar. Each hybrid displays Pglass droplets that range in size, with the smallest observed particle being 0.33 μm. This range is due to droplet coalescence which can also be observed in the SEM micrographs. Evidence of droplet coalescence can be best observed in the 2%, 5%, and 10% Pglass hybrids. The glass droplets also appear to be completely encased by the polyamide 6, which indicates good interaction between the phases.

Both the dynamic and tensile (static) mechanical properties of these new hybrid materials were also studied. A graph of the loss modulus versus temperature data shows that as Pglass is added to the polyamide 6 matrix, the Tg of the polyamide 6 decreases. Additionally, no glass transition peak is observed for the pure Pglass component in the hybrid, which should appear around 125° C. The glass transition temperatures determined from the loss modulus data is summarized in Table 3.

TABLE 3
Glass Transition temperature of the hybrid materials obtained from
Dynamic Mechanical Analysis

| Vol. % Polyamide | | |
|---|---|---|
| 6 in Hybrid | Vol. % Pglass | Tg (C.) |
| 100 | 0 | 58 ± 2.65 |
| 99 | 1 | 58 ± 0.02 |
| 98 | 2 | 57 ± 0.24 |
| 95 | 5 | 51 ± 0.45 |
| 90 | 10 | 48 ± 0.86 |

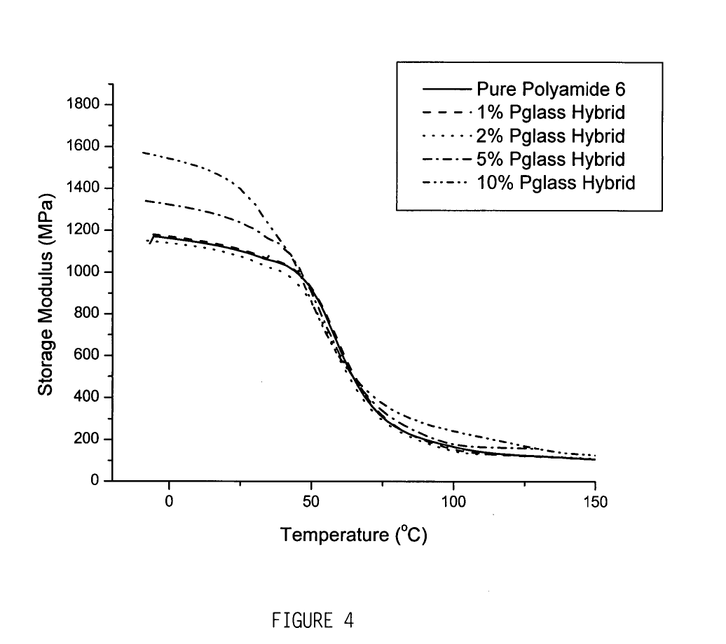

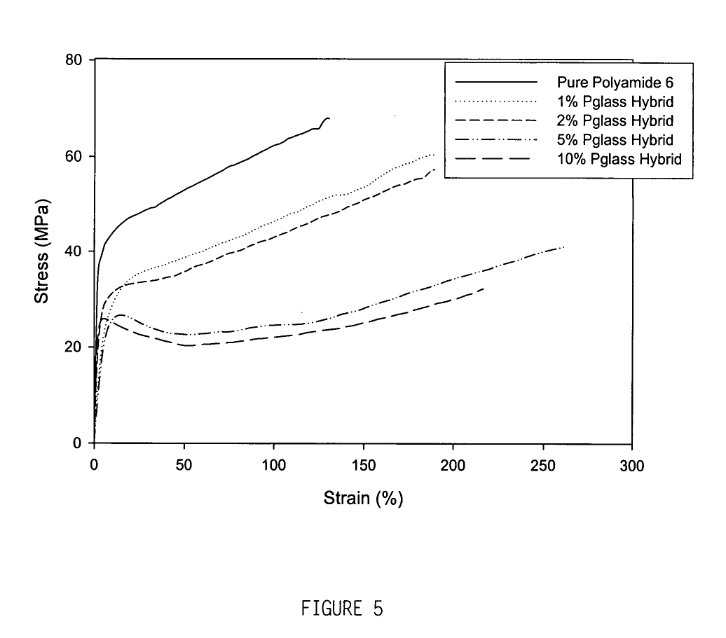

Attempts to model these glass transition temperatures with empirical equations in the literature such as the Fox (31) or the Gordon-Taylor (32) equations failed, as these equations predict a glass transition value that is between the glass transition temperatures of the individual components. From these results, it appears that the Pglass is acting as a macromolecular plasticizer for the polyamide 6. The exact nature of this plasticization effect is unknown. However some research have suggested that it could be due to the interfacial areas introduced into the composite (33-35). Phosphates are used as plasticizers for various polymers; however they are typically small molecules, unlike the Pglass used in this study (36). Common phosphate plasticizers have been reported to impart some flame resistance to polymers (36). We have also observed in our laboratory some preliminary evidence of the Pglass working to increase the flame resistance of the hybrid. It is important to note that there are other earlier reported cases of organic macromolecular plasticizers (17, 36), but not for inorganic Pglasses as in this study. The storage modulus data, shown in FIG. 4, for the hybrid systems is also interesting. The pure polyamide 6, 1% and 2% hybrids have essentially the same storage modulus at low temperatures. Increasing the Pglass content to 5% and 10% was found to increase the storage modulus of the hybrid at low temperatures. However, as the temperature is increased, the storage moduli of all the materials become nearly identical and independent of the Pglass volume fraction. The increased favorable interaction between the components is thought to be responsible for the observed interesting behavior depicted in FIGS. 4 and 5. We conjecture that the hybrid is beginning to act as a material with a single phase instead of a conventional glass-reinforced composite, thereby causing the storage moduli to converge.

FIG. 5 depicts the typical stress/strain curves for polyamide 6 hybrid material. Clearly, this figure shows that the addition of Pglass affects the failure mechanism of the hybrid in an intriguing manner as shown by the varying shapes of the curves with varying Pglass volume content. The yield point becomes more obvious as more Pglass is added (≧5 vol. %) to the polyamide 6. The stress/strain curves for the pure polyamide 6 and the hybrids with Pglass volume percent (≦2%) are typical of viscoelastic materials, being concave to the strain axis and showing no clear evidence of a yield stress. At higher Pglass volume percent (≧5%), the curves are consistent with that of a pseudo-ductile material showing a clear evidence of a yield stress, followed by a monotonic increase in stress with increasing strain as the material approaches failure. This behavior is akin to that of typical plasticized polymers (37).

As can be seen from Table 4, the Young's Modulus of the hybrid material is significantly less than that of the pure polyamide 6.

TABLE 4
Summary of Properties from Static Mechanical Testing

| Vol. % | | | |
|---|---|---|---|
| Polyamide 6 | Young's | Strain at | |
| in Hybrid | Modulus (Mpa) | Break (%) | Energy to Break (J/m³) |
| 100 | 1052.79 ± 52 | 176.57 ± 33 | 1.02E+08 ± 2.0E+07 |
| 99 | 539.29 ± 25 | 210.54 ± 19 | 1.03E+08 ± 1.2E+07 |
| 98 | 523.03 ± 19 | 189.45 ± 12 | 8.26E+07 ± 5.3E+06 |
| 95 | 472.22 ± 23 | 287.91 ± 46 | 8.06E+07 ± 2.4E+07 |
| 90 | 558.04 ± 36 | 248.60 ± 17 | 6.21E+07 ± 6.1E+06 |

The addition of the Pglass causes the polyamide to be less stiff. This behavior is also reflected in the strain at break values for the hybrid materials. The hybrids typically break at greater strains than that of the pure polyamide. It is reasonable to expect this trend to begin to reverse at some composition much greater than 10% Pglass where the increase in elongation would be offset by the brittle nature of the Pglass component, thereby causing failure at a relatively low strain. Table 4 also displays the energy to break as a function of composition. Energy to break is related to the area underneath a stress-strain curve. Although energy to break is dimensionally dependent, it gives a qualitative indication of the toughness of the material. While the addition of up to 5% by volume of Pglass generally preserves the toughness of the material, the 10% Pglass composition does show a marked decrease. This is most likely due to the brittle nature of the Pglass component.

### Example 2

### Study of the Effects of Melt Blending Speed on the Structure and Properties of Phosphate Glass/Polyamide 12 Hybrid Materials

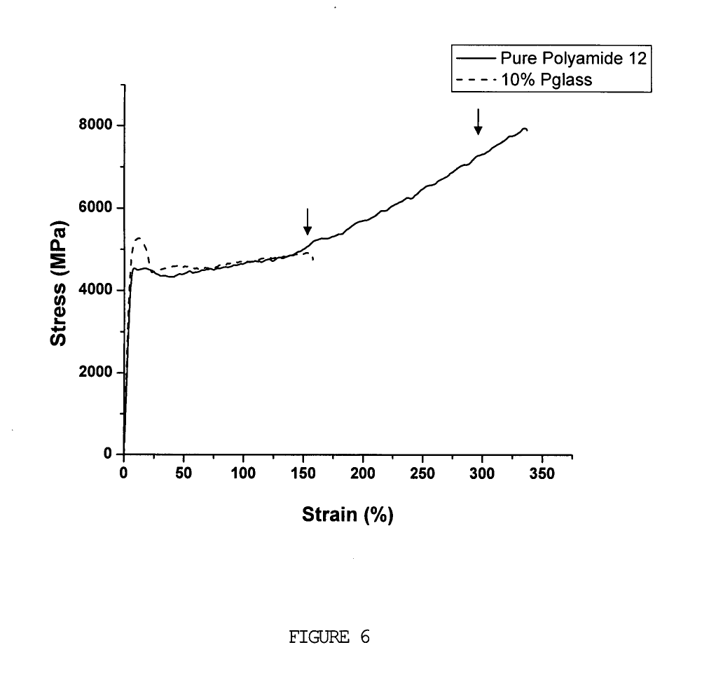

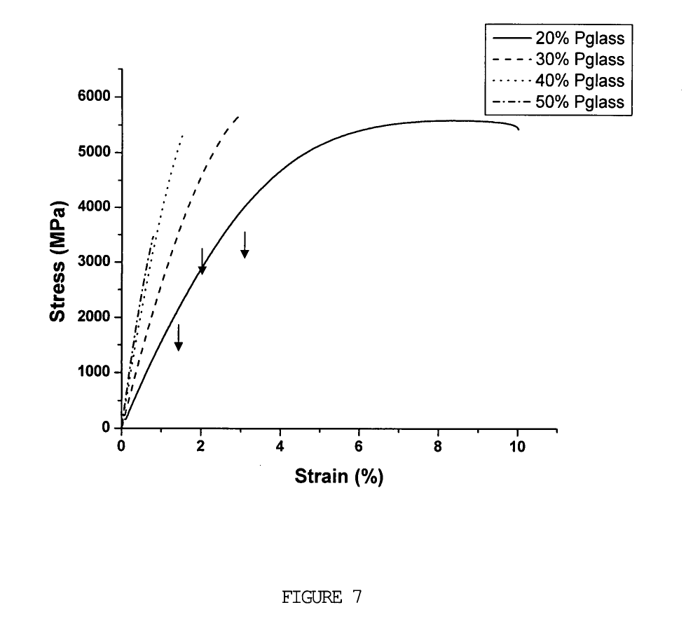

The effects of processing conditions on the rheology, crystallization kinetics, and tensile properties were investigated for the first time for phosphate glass/polyamide 12 hybrid systems, or nylon polymer composite, to understand their complex processing/structure/property relations. FIG. 6 depicts typical stress/strain curves for the hybrid materials with 10% Pglass volume percent. FIG. 7 depicts typical stress/strain curves for polyamide 12 with 20-50 volume percent P glass.

Increasing amounts of phosphate glass (Pglass) caused an increase in hybrid viscosity. Hybrid viscosity was also affected by processing (melt-mixing) speed and small amplitude oscillatory shear tests and scanning electron microscopy were used to qualitatively examine the hybrid morphology. The addition of Pglass caused a decrease in hybrid crystallinity that was unaffected by processing (melt-mixing) speed. The 2-parameter Avrami equation was successfully applied to the hybrid systems and Pglass was found to nucleate the growth of polyamide 12 crystals. The nucleation effect was found to be dependent upon concentration and processing history. The tensile properties of the hybrids were also studied and the Halpin-Tsai equation was applied to the results to determine the maximum packing fraction of the Pglass. These results provide a basis for the prediction of hybrid mechanical properties for different Pglass concentrations and processing histories. Further, because of their facile processability and desirable characteristics such as strong physicochemical interaction between the hybrid components and favorable viscoelasticity, these Pglass/polyamide 12 hybrids can be used as model systems for exploring feasibility of new routes for driving organic polymers and inorganic Pglass to self-assemble into useful organic/inorganic hybrid materials.

The low Tg Pglass used in this study has a molar composition of 50% SnF2+20% SnO+30% P2O5, a density of 3.75 g/cc, and a Tg of 125.7° C. The Pglass was synthesized in our laboratory using procedures previously reported elsewhere. (7) The tin fluoride and tin oxide were supplied by Cerac Inc. and the ammonium phosphate was supplied by Sigma-Aldrich. The polyamide 12 (Vestamid® L1700) was supplied by Creanova Inc. The density and melt flow index of the polyamide 12 are 1.02 g/cc and 120 g/10 min, respectively.

A ThermoHaake Polydrive® melt mixer with rotor roller blades was employed to thoroughly melt-mix the hybrid components prior to fabrication (compression and injection molding) of parts and test samples. The polyamide 12 and the Pglass were dried in a vacuum oven prior to melt-mixing. The Polydrive® mixer was preheated to 220° C. for at least 20 minutes before mixing in order to ensure that the instrument had reached thermal equilibrium. Before any of the hybrid components were added to the mixer, the instrument was calibrated at the appropriate mixing speed. The polyamide 12 was first added to the Polydrive® mixing bowl and allowed to mix for 5 min to yield a homogenous melt. The Pglass was subsequently added in the required amounts to the mixer and allowed to mix for an additional 10 min. Hybrids containing 10%, 20%, 30%, 40%, and 50% by volume of Pglass were prepared at rotor speeds of 50, 75, and 100 rpm. The hybrid materials were collected in “chunks” from the Polydrive® mixer for further processing.

Prior to further processing, the materials were dried in a vacuum oven. A portion of the melt-mixed material was compression molded into thin films for DSC studies described below. In order to conserve material, only hybrids containing 10%, 30%, and 50% Pglass were pressed into discs with a 25 mm diameter and 1.5 mm thickness for rheological measurements.

A Tetrahedron® Melt Press was used to prepare the compression molded samples. The press was preheated to 220° C. and the hybrid material was allowed to melt in the press before a load of 1,000 psi (6.895 MPa) was applied. The material was kept at 220° C. for 5 min before cooling to room temperature at 25° C./min. The molding pressure was then removed and the samples were collected. Another portion of the melt-mixed material from the Polydrive® mixer was ground into fine particles for subsequent injection molding using an IKA® A11 basic laboratory mill. The fine particles were injection molded into either dog-bone shapes, that were 4.32 mm wide and 1.55 mm thick with a gauge length of 28.70 mm, or into small rectangular bars using a DACA Microinjector® equipped with the appropriate mold. A mold residence time of 10 seconds, a barrel temperature of 220° C., and a mold temperature of 40° C. were used to obtain test samples with reproducible properties and no visible flaws.

All tested samples were dried for at least 48 hours or until constant weight was achieved in a vacuum oven prior to testing. The morphology of the hybrids was examined using a FEI Quanta® 200 Scanning Electron Microscope (SEM). Cross sections of the injection molded bars and compression molded discs were mounted onto aluminum posts, cryotomed, and gold sputtered before being examined by SEM. Rheological characterization was performed using a strain controlled ARES® rheometer. Testing was performed at 195° C. to ensure a viscosity that was within the limits of the instrument. Higher temperatures gave viscosities too low to be reliably measured by the rheometer. A strain sweep was performed on each composition that was examined to determine the linear viscoelastic region. The linear viscoelastic region varied with composition and therefore, linear strain amplitudes of 1%, 0.5%, and 0.1% were used for the 10%, 30%, and 50% Pglass hybrid systems, respectively, in the frequency sweep experiments. Several small amplitude oscillatory shear measurements were then performed on each sample to ensure reproducibility and the mean results are similar to those reported in this article. Liquid nitrogen-cooled Perkin-Elmer Pyris Diamond® DSC was used to measure the crystalline properties of the hybrids. An Alliance RT/10® Material Testing System was used to investigate the tensile properties of the hybrids. The dog-bone samples were conditioned in ambient conditions for 1 week prior to testing and the samples were deformed at a rate of 5.08 mm/min. Five samples were tested at each composition and the values were averaged to obtain the final results reported.

Morphology

It has been previously shown that as-prepared (“chunk”) material from the Polydrive® mixer displays a decrease in Pglass particle size with increasing mixer rotor speed (or shear rate), which is consistent with theory. (40, 41) However, the effect of rotor speed on morphology becomes more complicated upon injection or compression molding of the melt-mixed (“chunk”) material due to shear-induced coalescence and breakup. The 10 volume percent hybrid displays small droplets of Pglass dispersed in the polyamide 12 matrix. This morphology is maintained regardless of the mixing speed used. If one considers only the hybrids prepared at 50 rpm, it is clearly evident that the droplet morphology is maintained over the whole range of hybrid compositions studied. However, as the volume of Pglass is increased, larger Pglass droplets are formed and there is visual evidence of coalescence in the micrographs. When the processing speed is increased to either 75 or 100 rpm, the effect of coalescence becomes more pronounced. For hybrids prepared at these higher speeds, large agglomerations of Pglass are seen starting at 20 volume percent Pglass. As the Pglass content is increased further, the Pglass agglomerations continue to get larger, eventually forming a co-continuous or interpenetrating network-like morphology. This behavior is consistent with reported theoretical scaling models for droplet coalescence, which predict that small droplets are more likely to coalesce than large droplets and that increasing the volume fraction of the droplets increases the coalescence rate (42).

It is noteworthy that when the hybrid materials are compression molded, the morphology differs from that of injection molded samples. The differences in morphology between compression molded and injection molded samples become more prominent as the concentration of Pglass increases in the hybrids. The 10 volume percent Pglass/polymer hybrid samples show a droplet type morphology that is similar to that of the injection molded samples, with some slight evidence of coalescence. As the volume percent of Pglass is increased to 30%, the droplet morphology is maintained, but there is an increasing amount of Pglass droplet coalescence. When this sample is compared to the injection molded sample already discussed, it is easy to see that more Pglass droplet coalescence occurs during injection molding for this 30% Pglass/polymer hybrid composition. The 50% Pglass/polymer hybrids display a very different morphology to an extent that depends on the rotor speed (or shear rate) used to melt-mix the hybrid in the Polydrive® mixer. For example, the hybrid sample melt-mixed at 50 rpm shows a significant degree of Pglass droplet coalescence, but there is still a large number of small droplets in the system as the figure shows. The 50% Pglass/polymer hybrids melt-mixed at 75 rpm and 100 rpm display large agglomerated structures that are typical of co-continuous type morphologies. The morphology corresponding to the sample melt-mixed at 75 rpm is finer and more connected than that of the sample melt-mixed at 100 rpm.

The observed differences in morphology between compression molded and injection molded samples can be rationalized based on the different amount of shear and mold residence (heating) time experienced by the material during the different molding processes with varying melt deformation environment and histories. During compression molding, the material is subjected to relatively lower shear and more mold residence time at elevated temperature with respect to injection molding. While the lower shear rate the material experiences during compression molding will decrease the capillary number and should in theory favor coalescence, the longer mold residence time at elevated temperature provides more time for the material to relax and change the shear-induced morphology.

Viscoelasticity

By examining these materials using small amplitude oscillatory shear flow experiments, the morphology of the hybrids and its influence on viscoelastic properties can be further probed. The complex viscosity of compression molded hybrids as a function of frequency for all the Polydrive® melt-mixing speeds used in this study shows that regardless of Polydrive® melt-mixing speed used, the complex viscosity increases with increasing Pglass content, which is consistent with Taylor's theory (43). Comparing the frequency dependence of storage modulus for the individual hybrid compositions that were melt-mixed at different speeds provides additional information concerning the effect of the Polydrive® melt-mixing speed on the rheology of these materials. It has been shown that storage modulus increases with decreasing dispersed phase size. (44) The hybrids containing 10 volume percent Pglass that were prepared at 75 rpm and 100 rpm show similar storage moduli, implying that these two hybrids have similar microstructures. A similar trend is seen for the 30 volume percent Pglass compositions prepared at 75 and 100 rpm. In addition, the dispersed phase in these hybrids is observed to be smaller than that of the hybrids prepared at 50 rpm. The small Pglass droplet sizes, which dominate the rheology of these systems, were measured and found to be consistent with the analysis of the frequency dependence of the storage modulus as shown in Table 5.

TABLE 5
Particle size distribution for select Pglass/polyamide 12 hybrids
prepared at different melt-mixing speeds

| | Mean Particle Size of 10 | Mean Particle Size of 30 |
|---|---|---|
| Melt-mixing | Vol. % Pglass Hybrid | Vol. % Pglass Hybrid |
| Speed | (μm) | (μm) |
| 50 rpm | 3.37 ± 0.64 | 1.71 ± 0.36 |
| 75 rpm | 2.10 ± 0.54 | 1.18 ± 0.31 |
| 100 rpm | 2.00 ± 0.92 | 1.24 ± 0.38 |

The observed trend in the viscoelastic material functions of the hybrids with low Pglass concentration hybrids (10% & 30% Pglass) discussed above changes when the 50% Pglass/polymer hybrid was examined. The 50% Pglass/polymer hybrid prepared using a Polydrive® mixer at 50 rpm displays the highest storage modulus, while the hybrid prepared at 75 rpm displays the lowest modulus. These results can be explained by examining the corresponding micrographs of these materials. The 50% Pglass/polymer hybrid prepared at 50 rpm displays some large coalesced structures, but the majority of the Pglass is dispersed as discrete droplets, which results in this material having the highest storage modulus. The 50% Pglass/polymer hybrid prepared at 100 rpm hybrid shows individual, large Pglass structures, while the 50% Pglass/polymer hybrid prepared at 75 rpm hybrid shows a relatively finer, but more interconnected Pglass phase morphology. This interconnected Pglass phase structure would act as a single large dispersed domain, and thereby causing the lowest storage modulus. The current work has shown conclusive experimental evidence that melt-mixing speed as used here affects both the final morphology and the rheological properties of these unique materials.

Crystalline Properties

As a polymeric material is melt-processed to produce a part, it undergoes a transition from the melt (or liquid) to a solid state. Polyamide 12 is a semi-crystalline material and will form crystals during this transition from liquid to solid state. As the amount of crystallinity and the speed at which the crystals form impact the final properties of a polymeric material, it is important to understand the effect of Polydrive® melt-mixing speed on these parameters. Percent crystallinity is usually determined by dividing the observed heat of fusion by the standard heat of fusion for the material. The percent crystallinity of the hybrid materials was estimated using a slightly modified eq. 4. Table 6 summarizes the percent crystallinity that was determined for these hybrids.

TABLE 6
Percent Crystallinity of Pglass/polyamide 12 hybrids prepared
at different melt-mixing speeds

| Vol. % | | | |
|---|---|---|---|
| Polymer | 50 rpm X_{c} | 75 rpm X_{c} | 100 rpm X_{c} |
| 100% | 54% ± 1.98% | 54% ± 1.98% | 54% ± 1.98% |
| 90% | 28% ± 0.32% | 27% ± 1.11% | 29% ± 0.33% |
| 80% | 16% ± 1.74% | 16% ± 0.80% | 15% ± 0.57% |
| 70% | 8% ± 0.19% | 9% ± 0.17% | 9% ± 0.17% |
| 60% | 4% ± 0.12% | 5% ± 0.05% | 5% ± 0.07% |
| 50% | 3% ± 0.22% | 3% ± 0.06% | 3% ± 0.26% |

A value of 95 J/g was used as the standard heat of fusion for pure polyamide 12. (45) The observed heat of fusion was obtained from a DSC temperature scan at a heating rate of 10° C./min. It can be seen from this table that as the content of Pglass is increased, the crystallinity of the system decreases (Table 6). This experimental observation is consistent with reported studies on Pglass/LDPE and Pglass/Polyamide 6 hybrid systems, where it was shown that the Pglass inhibited crystallite formation. It is believed that the Pglass is acting similarly in the hybrid system of the present study and is a common feature of hybrid systems. The effect of melt-mixing speed on the percent crystallinity is negligibly small. There appears to be a slight increase (approximately 1%) in the overall crystallinity when comparing the hybrids prepared at Polydrive® mixing speed of 50 rpm to that prepared at 75 rpm and 100 rpm. The slight increase in the overall crystallinity just mentioned could be within the accuracy of the DSC instrument.

Although the percent crystallinity of the hybrid was unaffected by the Polydrive® melt-mixing speed, the rate at which the crystals grow and how they grow was impacted. For the isothermal tests, the sample was heated to 220° C. and held there for 3.5 minutes to eliminate previous thermal history. The sample was then quenched to 160° C. and held there for 17 minutes. For the Pglass/polyamide 12 hybrid system, only measurements performed at 160° C. displayed isotherms that were suitable for Avrami analysis. Other temperatures were examined, but the crystallization peak was either unobservable or very broad. The results of these tests are summarized in Table 7.

TABLE 7
Avrami parameters for Pglass/polyamide 12 hybrids prepared at different melt-mixing
speeds

| Vol. % | 50 rpm | | 75 rpm | | 100 rpm | |
|---|---|---|---|---|---|---|
| Glass | slope (n) | k (s⁻¹) | slope (n) | k (s⁻¹) | slope (n) | k (s⁻¹) |
| 0 | 5.03 | 1.67 × 10⁻¹¹ | 5.03 | 1.67 × 10⁻¹¹ | 5.03 | 1.67 × 10⁻¹¹ |
| 10 | 2.86 | 6.28 × 10⁻⁸ | 3.85 | 3.41 × 10⁻⁹ | 3.43 | 2.19 × 10⁻⁸ |
| 20 | 3.55 | 2.63 × 10⁻⁸ | 3.50 | 1.07 × 10⁻⁷ | 3.50 | 2.09 × 10⁻⁷ |
| 30 | 3.94 | 1.99 × 10⁻⁹ | 3.70 | 7.02 × 10⁻⁹ | 3.10 | 1.48 × 10⁻⁶ |
| 40 | 3.93 | 5.22 × 10⁻⁹ | 3.99 | 7.47 × 10⁻⁹ | 2.64 | 1.03 × 10⁻⁵ |
| 50 | 4.58 | 3.50 × 10⁻¹⁰ | 3.24 | 5.03 × 10⁻⁹ | 2.35 | 1.2 × 10⁻⁵ |

The calculated value of n for the pure polyamide 12 is consistent with reported values for pure polyamide 12. (46) The growth factor is relatively unaffected by the melt-mixing speed for hybrids with ≦20% Pglass concentration. These hybrids, except for the 10% Pglass/polymer prepared at 50 rpm, displayed n values that are greater than 3.43. Values of n greater than 3.43 are indicative of athermal nucleation, with three dimensional growth in a sheaf-like geometry. (21) The 10% Pglass/polymer hybrid prepared at 50 rpm displayed an n value of 2.86, indicating that the shape of the crystal changed from a sheaf to a sphere. It is likely that the consistently poor isotherm at the test temperature that is observed for the composition just mentioned is the cause of the deviation of the n value. The remaining hybrids that were prepared at 50 rpm were all observed to display an n value greater than 3.5 that corresponds to no change in the growth process. As the melt-mixing speed is increased to 75 rpm, the growth of the crystals in the 50 volume percent Pglass/polymer hybrid is impacted. This last hybrid composition has an n value approaching 3, which again indicates a shift to a more spherical growth like geometry. As the melt-mixing speed was further increased to 100 rpm, the n value changes at relatively low Pglass concentrations. At 30 volume percent Pglass concentration in the hybrid, the n value is changed to 3.10, and it reduces further as the Pglass concentration is increased. For the 50 volume percent Pglass/polymer hybrid, the n value indicates another change in the growth process to two dimensional growth in a circular geometry. The opacity of the Pglass hybrids prevented visual confirmation of the growth factors through polarized light microscopy.

The growth rate of the crystals was also affected by composition and melt-mixing speed. In general, the Pglass acts as a nucleating agent for the growth of the polymer crystals. In contrast to typical nucleating agents, Pglass merely accelerates the growth of the crystals; it does not induce the formation of new crystals. The nucleating effect of the Pglass has been reported by Guschl et. al (47, 5) for low density polyethylene and polypropylene hybrid systems. However, the nucleation effect of the Pglass is affected by its concentration in the Pglass/polyamide 12 hybrid systems. The melt-mixing speed also impacts the growth rate. In both the hybrids prepared at 50 rpm and 75 rpm, the Pglass causes a nucleation effect that reaches its maximum at a Pglass concentration of 20 volume percent. As the Pglass concentration is increased further, the growth rate slows down slightly. When the melt-mixing speed is increased to 100 rpm, the growth rate does not reach a maximum at 20 volume percent Pglass, but continues to increase with increasing Pglass content in the hybrids. In summary, the crystalline properties of the Pglass/polyamide 12 hybrids described above suggest that melt-mixing speed as used in this study does not significantly affect the overall crystallinity of the hybrid material. However, the shape and growth rate of the crystals is greatly impacted by the melt-mixing speed of the material, thereby leading to the conclusion that the amorphous Pglass phase in the hybrids greatly influences the growth of the polyamide 12 crystals in the hybrid systems studied. These crystallinity results also suggest that any observed influence of the melt-mixing speed on the hybrid mechanical properties (discussed below) can be ascribed solely to the overall morphology of the hybrid material.

Tensile Properties

Mechanical properties play a large role in determining if a material can be used for a certain application. The mechanical properties of a polymer blend depend on the individual component properties, blend composition, and on the final morphology of the material. Polymer composite properties depend on factors such as the type of filler, concentration of filler, and how the filler is arranged in the material, i.e. packing fraction. The Pglass/polymer hybrids of the present study fit in between these two types of polymeric materials. As already discussed, the mode of Pglass dispersion inside the polymer matrix of the hybrids encompasses a number of different morphologies similar to that reported for typical polymer blends. However, the Pglass phase after solidification of the hybrid is a rigid inorganic glass at room temperature in remarkable contrast to classical polymer blends. By systematically investigating the effect of melt-mixing speed on the hybrid tensile properties, the processing/structure/property relationship of this important class of polymeric materials can be understood. This understanding is crucial to controlling the fabrication of Pglass/polymer hybrid parts with reproducible properties for a number of applications.

The pure polyamide 12 displays typical polymer behavior with a clearly defined yield stress. As Pglass is added to the system, the yield stress disappears and the curves begin to resemble that of brittle solids. In Table 8 the effect of melt-mixing speed on strain at break is shown. The hybrids melt-mixed in the Polydrive® at 50 rpm display the highest strain at break for all the hybrid compositions while the hybrids melt-mixed at 100 rpm display the lowest strain at break for compositions containing less than 20 volume percent Pglass. The observed trend changes at the higher Pglass concentrations, where the hybrids melt-mixed at 100 rpm have ultimate strains approaching that of the hybrids melt-mixed at 50 rpm. While the hybrids melt-mixed at 75 rpm tended to exhibit the lowest strain at break, they also tended to have the highest modulus of the materials.

TABLE 8
Strain at break for Pglass/polyamide 12 hybrids prepared
at different melt-mixing speeds

| Volume | | | |
|---|---|---|---|
| Percent | Strain at Break (%) | | |
| Pglass | 50 rpm | 75 rpm | 100 rpm |
| 0 | 318.34 ± 46.10 | 318.34 ± 46.10 | 318.34 ± 46.10 |
| 10 | 159.11 ± 65.37 | 113.93 ± 64.06 | 13.21 ± 8.15 |
| 20 | 8.23 ± 0.97 | 5.00 ± 0.49 | 4.34 ± 0.49 |
| 30 | 2.68 ± 0.51 | 1.63 ± 0.26 | 2.69 ± 0.36 |
| 40 | 1.56 ± 0.13 | 0.84 ± 0.10 | 1.30 ± 0.22 |
| 50 | 0.76 ± 0.23 | 0.60 ± 0.04 | 0.94 ± 0.14 |

While it is clear from the preceding discussion that the hybrid materials melt-mixed at 75 rpm are best for high stiffness applications and the hybrids melt-mixed at 50 rpm and 100 rpm show a slightly lower stiffness and more strain at break, it is more important to be able to predict the behavior of these materials from the properties of the hybrid components. The Halpin-Tsai equation (eq. 5) is a useful relationship used by many researchers to accurately predict the modulus of a polymer reinforced by a rigid filler. (48)

$${E}_{c} = {E}_{m} ( \frac{1 + AB {ϕ}_{f}}{1 - B ψ {ϕ}_{f}} ) \qquad ( 5 )$$

In this equation, E_{c} is the predicted modulus of the composite, Eₘ is the modulus of the polymer matrix, and φ_{f} is the volume fraction of filler in the system. The constant A accounts for the Poisson's ratio of the matrix and the geometry of the filler. In the case of spherical fillers A is expressed as shown in equation 6, where νₘ is the Poisson's ratio of the matrix.

$$A = \frac{7 - 5 {υ}_{m}}{8 - 10 {υ}_{m}} \qquad ( 6 )$$

The constant B depends on the relative moduli of the filler (E_{f}) and matrix phases and is defined in equation 7.

$$B = \frac{\frac{{E}_{f}}{{E}_{m}} - 1}{\frac{{E}_{f}}{{E}_{m}} + A} \qquad ( 7 )$$

The factor ψ can be approximated by equation 8, assuming the modulus of the filler is significantly greater than that of the polymer and if the Einstein coefficient is much greater than 1.0.

$$ψ = 1 = \frac{{ϕ}_{m}}{p} [ p {ϕ}_{f} + ( 1 - p ) {ϕ}_{m} ] \qquad ( 8 )$$

In equation 8, p is the maximum packing fraction of the filler. The Poisson's ratio is one of the unknown variables in the preceding equations. A polymer above its Tg is often assumed to have a Poisson's ratio of 0.5. (49) However, the polyamide 12 is below its Tg at room temperature. An effective Poisson's ratio can be calculated for a filled system as shown in equation 9 (50):

$${υ}_{e} = {υ}_{m} - \frac{2 ( {υ}_{m} - {υ}_{f} ) ( 1 - {υ}_{m}^{2} )}{[ {ϕ}_{f} ( 1 - {υ}_{m} - 2 {υ}_{m}^{2} ) + ( 1 + {υ}_{m} ) ]} {ϕ}_{f} \qquad ( 9 )$$

where ν_{f} is the Poisson's ratio of the filler. All of the quantities in Equation 5, except for the packing fraction, are known or can be calculated using the above equations and measured values of 0.655 GPa and 29.29 GPa for the matrix (polyamide 12) and filler (Pglass) moduli, respectively. The Poisson's ratio for the pure polyamide 12 and the Pglass are 0.35 and 0.25, respectively (26). By systematically varying the unknown packing fraction, the theoretical (calculated) modulus of the hybrid can be brought within 2% of the measured hybrid modulus. The packing fractions used to achieve such a result are shown in Table 9.

TABLE 9
Packing fractions of different Pglass/polyamide 12 hybrids
prepared at different melt-mixing speeds

| Volume | | | |
|---|---|---|---|
| Percent | Packing Fraction | | |
| Pglass | 50 rpm | 75 rpm | 100 rpm |
| 10% | 0.7405 | 0.5236 | 0.37 |
| 20% | 0.632 | 0.49 | 0.49 |
| 30% | 0.42 | 0.385 | 0.39 |
| 40% | 0.38 | 0.355 | 0.46 |
| 50% | 0.465 | 0.375 | 0.47 |

The 10 volume percent Pglass hybrids all display packing fractions that have physical meanings corresponding to face-centered cubic packing (50 rpm hybrid), simple cubic packing (75 rpm hybrid), and random close packing, agglomerated (100 rpm) respectively. (48) The 20 volume percent melt-mixed at 50 rpm hybrid displays a packing fraction that corresponds to a filler distribution that is random close packing, non-agglomerated. The other hybrids' packing fraction values fall between 0.355 and 0.49. By using weighted averages of the calculated packing fractions, it should be possible to accurately calculate a modulus for any polyamide 12 hybrid that contains between 10 and 50 volume percent Pglass prepared at any speed between 50 and 100 rpm. The weighted packing fraction averages just mentioned are thought to be reasonable estimates of the unknown packing fractions of the actual complex heterogeneous structures (agglomerated/non-agglomerated randomly packed) of the hybrids already discussed.

The novel hybrid materials of this study are known to exhibit complex interpenetrating and co-continuous microstructures unrealizable in conventional mineral filler reinforced polymers as already discussed. At ambient conditions, the hybrids are comprised of very rigid inorganic Pglass phase and a relatively weak, viscoelastic organic polymer phase. As a result, the difference between the stiffness of the individual constituent phases can be several orders of magnitude. Furthermore, because of the partial miscibility of the constituent phases, the local properties can vary in a non-trivial manner across the interfaces. (51, 52, 53) It is precisely a combination of all these factors that brings about the interesting and advantageous properties of the present hybrids. But it is also the same factors that make it so difficult to develop accurate theoretical equations for predicting the properties of the hybrids.

It is noteworthy that accurate rational models have been developed for predicting elastic properties of two-phase composites with spherical, ellipsoidal and infinitely long cylindrical inclusions. (54) However, in most cases this rational theoretical analysis has been limited to the domain of dilute filler concentrations, where one can effectively neglect the interactions between the inclusions. Recently, a generic finite-element based approach for predicting the behavior and properties of multi-phase materials comprised of anisotropic, arbitrarily shaped and oriented phases has been reported by Gusev. (55, 56)

The mechanical properties of the hybrid materials are both interesting and counterintuitive. Typically, as conventional solid glass filler is added to a system, an increase in Young's modulus and a decrease in the strain at break is observed (37). However, the observed mechanical properties of the hybrids are remarkably similar to that obtained when a plasticizer is added to a pure polymer (38, 39). This is further evidence indicating that the Pglass is acting as a macromolecular plasticizer for the pure polyamide 6. The present invention is also the first attempt to elucidate a processing/structure/property relationship for the Pglass/polyamide 12 hybrid materials. By studying the effect of melt-mixing speed on the liquid state, via rheology; the transition between liquid and solid states, via crystallization properties; and solid state physical properties, the presently disclosed invention will be useful to understand the complex interplay of the hybrid morphology and properties during processing. The examples presented reveal an increase in hybrid viscosity with increasing Pglass concentration. As expected, the effect of processing conditions, which dramatically affects morphology, also impacted the rheology of individual compositions. It was also determined that melt-mixing speed did not affect the overall crystallinity of the hybrid systems, but it played a large role in determining the crystallization parameters of the material. Further, have elucidated the effect of melt-mixing speed on the hybrid tensile properties. The Halpin-Tsai equation was successfully applied to these materials, providing a foundation for predicting the final properties of hybrids based on the hybrid component properties and processing conditions.

### REFERENCES

1. J. U. Otaigbe and G. H. Beall, Trends in Polymer Science, 5, 369-379 (1997).
2. R. K. Brow. Structure, Properties and Applications of Phosphate and Phosphate-Containing Glasses, University of Missouri-Rolla, 1999.
3. J. U. Otaigbe and D. O. Adams, Journal of Environmental Polymer Degradation, 5, 199-207 (1997).
4. J. U. Otaigbe, C. J. Quinn and G. H. Beall, Polymer Composites, 19, 18-22 (1998).
5. P. C. Guschl and J. U. Otaigbe, Journal of Applied Polymer Science, 90(2003).
6. R. T. Young, M. A. McLeod and D. G. Baird, Polymer Composites, 21, 900-917 (2000).
7. S. B. Adalja, J. U. Otaigbe and J. Thalacker, Polymer Engineering and Science, 41, 1055-1067 (2001).
8. S. B. Adalja and J. U. Otaigbe, Applied Rheology, 11, 10-18 (2001).
9. R. E. N. Castro, E. A. Toledo, A. F. Rubira and E. C. Muniz, Journal of Materials Science, 38, 699-703 (2003).
10. S.-K. Cheng, C.-C. Wang and C.-Y. Chen, Polymer Engineering and Science, 43(2003).
11. H. Veenstra, B. J. J. van Lent, J. van Dam and A. Posthuma de Boer, Polymer, 40, 6661-6672 (1999).
12. D. Bourry and B. D. Favis, Journal of Polymer Science: Part B: Polymer Physics, 36, 1889-1899 (1998).
13. S. Zheng, J. Huang, W. Liu, X. Yang and Q. Guo, European Polymer Journal, 32, 757-760 (1996).
14. V. A. Deimede, K. V. Fragou, E. G. Koulouri, J. K. Kallitsis and G. A. Voyiatzis, Polymer, 41(2000).
15. L. S. Hersh, E. C. Onyiriuka and W. Hertl, Journal of Materials Research, 10(1995).
16. D. M. Laura, H. Keskkula, J. W. Barlow and D. R. Paul, Polymer, 43, 4673-4687 (2002).
17. V. Balsamo, N. Calzadilla, G. Mora and A. J. Muller, Journal of Polymer Science: Part B: Polymer Physics, 39, 771-785 (2001).
18. E. Martuscelli, M. Pracella and W. P. Yue, Polymer, 25, 1097-1106 (1984).
19. Y. Shi and S. A. Jabarin, Journal of Applied Polymer Science, 81, 11-22 (2001).
20. T. Nishi and T. T. Wang, Macromolecules, 8, 909-915 (1975).
21. U. W. Gedde. Kluwer, Boston, 1999, p 169-198.
22. X. J. Xu, D. E. Day, R. K. Brow and P. M. Callahan, Physics and Chemistry of Glasses, 36, 264-271 (1995).
23. X. J. Xu and D. E. Day, Physics and Chemistry of Glasses, 31, 183-187 (1990).
24. P. A. Tick, Physics and Chemistry of Glasses, 25, 149-154 (1984).
25. N. H. Ray, British Polymer Journal, 163-177 (1979).
26. J. Brandrup and E. H. Immergut, Eds. Polymer Handbook, Wiley-Interscience, New York, 1989.
27. J. D. Hoffman and J. J. Weeks, Journal of Research of the National Bureau of Standards, 66A(1962).
28. B. G. Risch, G. L. Wilkes and J. M. Warakomski, Polymer, 34, 2330-2343 (1993).
29. C.-S. Park, K.-J. Lee, J.-D. Nam and S.-W. Kim, Journal of Applied Polymer Science, 78, 576-585 (2000).
30. M. Liu, Q. Zhao, Y. Wang, C. Zhang, Z. Mo and S. Cao, Polymer, 44, 2537-2545 (2003).
31. P. C. Painter and M. M. Coleman, Fundamentals of Polymer Science, Technomic, Lancaster, 1997.
32. J. L. Eguiburu, J. J. Iruin, M. J. Femandez-Berridi and J. San Roman, Polymer, 39, 6891-6896 (1998).
33. B. J. Ash, R. W. Siegel and L. S. Schadler, Journal of Polymer Science: Part B: Polymer Physics, 42, 4371-4383 (2004).
34. C. G. Reid and A. R. Greenberg, Journal of Applied Polymer Science, 39, 995-1014 (1990).
35. Y. Sun, Z. Zhang, K.-S. Moon and C. P. Wong, Journal of Polymer Science: Part B: Polymer Physics, 42, 3849-3858 (2004).
36. B. L. Wadey. in Encyclopedia of Physical Science and Technology; Academic Press, 2002.
37. L. E. Nielsen and R. F. Landel, Mechanical Properties of Polymers and Composites, Marcel Dekker, New York, 1994.
38. S. Jacobsen and H. G. Fritz, Polymer Engineering and Science, 39, 1303-1310 (1999).
39. M. Baiardo, G. Frisoni, M. Scandola, M. Rimelen, D. Lips, K. Ruffieux and E. Wintermantel, Journal of Applied Polymer Science, 90, 1731-1738 (2003).
40. K. Urman and J. U. Otaigbe. SPE Antec Tech. Papers 62(2), pp. 2063-2066 (2004).
41. I. Vinckier, P. Moldenaers and J. Mewis, Journal of Rheology, 40, 613-631 (1996).
42. C. L. Tucker III and P. Moldenaers, Annual Review of Fluid Mechanics, 34, 177-210 (2002).
43. G. I. Taylor, Proceedings of the Royal Society of London. Series A, Containing Papers of a Mathematical and Physical Character, 138, 41-48 (1932).
44. H. K. Jeon and J. K. Kim, Polymer, 39, 6227-6234 (1998).
45. S. Gogolewski, K. Czerniawska and M. Gasiorek, Journal of Colloid and Polymer Science, 258, 1130-1136 (1980).
46. K. P. Chuah, S. N. Gan and K. K. Chee, Polymer, 40, 253-259 (1998).
47. P. C. Guschl, J. U. Otaigbe and E. P. Taylor, SPE Antec Tech. Papers 61(2), 2137-2141 (2003).
48. L. E. Nielsen and R. F. Landel, Mechanical Properties of Polymers and Composites, Marcel Dekker, New York, 1994.
49. L. Flandin, A. Chang, S. Nazarenko, A. Hiltner and E. Baer, Journal of Applied Polymer Science, 76(2000).
50. M. Uschitsky, E. Suhir and G. W. Kammlott, Journal of Electronic Packaging, 123, 260-267 (2001).
51. B. C. Tischendorf, D. J. Harris, J. U. Otaigbe and T. M. Alam, Chem. Mater., 14 (2002).
52. A. Rawal, K. Urman, J. Otaigbe and K. Schmidt-Rohr, Manuscript in preparation.
53. K. Urman and J. U. Otaigbe, Journal of Polymer Science, Part B: Polymer Physics, 44, 441-450 (2006).
54. R. M. Christensen, Mechanics of Composite Materials, Krieger Publishing Company, Malabar, Fla., 1991.
55. A. A. Gusev, Macromolecules, 34, 3081 (2001).
56. A. A. Gusev, P. J. Hine and I. M. Ward, Journal of the Mechanics and Physics of Solids, 45, 1449 (1997).

What is claimed is:

1. A nylon polymer composite comprising a low glass transition temperature phosphate glass and a nylon polymer.

2. The nylon polymer composite of claim 1 wherein the phosphate glass is a tin fluorophosphate glass.

3. The nylon polymer composite of claim 2 wherein the phosphate glass comprises: SnF₂, SnO, and P₂O₅.

4. The nylon polymer composite of claim 3 wherein the phosphate glass comprises: about 50% SnF₂, about 20% SnO and about 30% P₂O₅.

5. The nylon polymer composite of claim 1 wherein the nylon polymer is polyamide 6.

6. The nylon polymer composite of claim 1 wherein the nylon polymer is polyamide 12.

7. The nylon polymer composite of claim 1 comprising about 1% to about 60% by volume phosphate glass.

9. The nylon polymer composite of claim 1 wherein said phosphate glass is miscible within said nylon polymer.

10. The nylon polymer composite of claim 1 wherein the T_{g} of said nylon polymer composite is lower than the melting point of the nylon polymer.

11. The nylon polymer composite of claim 1 wherein the phosphate glass is encased within the nylon polymer.

12. The nylon polymer composite of claim 1 formed by melt mixing the phosphate glass and nylon polymer until homogenized.

13. The nylon polymer composite of claim 12 wherein the melt-mixing is about 50 to about 100 rpm.

14. A method of making a nylon polymer composite: melt-mixing a low glass transition temperature phosphate glass and a nylon polymer.

15. The method of claim 14 wherein the nylon polymer is polyamide 6 or polyamide 12.

16. The method of claim 14 wherein the low glass transition temperature phosphate glass a tin fluorophosphate glass.

16. The method of claim 14 further comprising the step of compression molding the nylon polymer composite.

17. The method of claim 14 further comprising the step of injection molding the nylon polymer composite.
